(19) United States
(12) Patent Application Publication
(10) Pub. No.: US 2009/0095099 A1
(43) Pub. Date: Apr. 16, 2009

(54) SPEED CHANGE MECHANISM AND ROTARY ACTUATOR

(75) Inventor: Masashi Konomoto, Tokyo (JP)

Correspondence Address: Young & Thompson, 745 S. 23rd Street., Second Floor, Arlington, VA, 22202, US

(73) Assignee: THK CO., LTD., Tokyo (JP)

(21) Appl. No.: 11/912,958

(22) PCT Filed: Apr. 26, 2006
(86) PCT No.: PCT/JP2006/308698

§ 371 Date: Oct. 29, 2007

(30) Foreign Application Priority Data
Apr. 28, 2005 (JP) 2005-133597

(51) Int. Cl. F15B 15/06; F16H 25/22

(52) U.S. Cl. 74/89.35; 74/424.82

(57) ABSTRACT

A rotary actuator 10 includes: a housing 40; a first screw shaft 11 fixedly disposed on one end side of the housing 40 and formed with a spiral screw groove 12 in its outer peripheral surface; a second screw shaft 21 disposed on another end side of the housing 40 to be rotatable around an axis in a state of restricting a movement in an axial direction and formed, in an outer peripheral surface thereof, with a spiral screw groove 22; a nut member formed, in an inner peripheral surface thereof, with two kinds of nut grooves 31 and 32 corresponding to the screw grooves 12 and 22 formed to the first and second screw shafts 11 and 21 so as to be engaged therewith. The screw groove 12 formed to the first screw shaft 11 has a lead larger than a lead of the screw groove 22 formed to the second screw shaft 21.

### TECHNICAL FIELD

The present invention relates to a speed change mechanism and a rotary actuator improved in a manner such that the speed change mechanism and the rotary actuator are connected to a stabilizer to be thereby selectively switched in accordance with generation of twisting rigidity.

### BACKGROUND ART

A vehicle body of an automobile or like is provided with a stabilizer for controlling inclination or tilting of a vehicle body while maintaining comfortable ride quality at a cornering drive time of the automobile. Such stabilizer has a simple structure in which a stabilizer bar having a U-shaped configuration is connected to right and left suspension arms. When the vehicle body is inclined and tires on one side of the automobile sink, the stabilizer bar is twisted and acts as spring, and on the other hand, when tires on both sides of the automobile sink simultaneously, the stabilizer is not twisted and does not act as spring. Accordingly, the provision of the stabilizer can contribute the stabilizing of attitude of the vehicle body.

In such a stabilizer, in order to perfume more effective attitude controlling of the vehicle body, technologies have been variously improved. For example, in the following Patent Publication 1, there is disclosed a stabilizer of hydraulically variable type in which a stabilizer bar is divided into two sections, which are connected by a rotary actuator. According to this Patent Publication 1, by controlling the rotary actuator disposed at the divided portion, it becomes possible to add, to the vehicle body, a rolling motion in a reverse direction corresponding to rolling moment acting on the vehicle body by a centrifugal force, so that the rolling caused on the vehicle body can be effectively controlled.

Furthermore, a stabilizer disclosed in the following Patent Publication 2 includes a rotary actuator composed of a pair of screw mechanisms in reverse-screw relation, a piston engaged with the paired screw mechanisms, and a cylinder housing disposed so as to cover the piston and form two operating fluid chambers. The paired screw mechanisms include a pair of rotation shafts to which screw grooves (threads) wound reversely with the same lead are formed, respectively, and rotating torques in reverse directions are caused to the paired rotation shafts respectively. Furthermore, the rotating actuator disclosed in the Patent Publication 2 has a structure capable of controlling the communication of the operating fluid between the two operating fluid chambers, and therefore, according to the stabilizer of this Patent Publication 2, it is described that the rolling control of the vehicle can be preferably performed.

Patent Publication 1: Japanese Patent Laid-open Publication No. HEI 7-40731

Patent Publication 2: Japanese Patent Laid-open Publication No. 2004-122944.

### DISCLOSURE OF THE INVENTION

### Problems to be Solved by the Invention

However, a vane-type rotary actuator is adopted as a rotary actuator used for the stabilizer disclosed in the Patent Publication 1, and therefore, this lacks in reliability in terms of workability. That is, the vane-type rotary actuator has a complicated structure such that a sliding wall sliding while defining the fluid chambers has a rectangular shape, so that high working performance is required for the constitutional members or like. However, the sliding wall having complicated structure has a problem in sealing performance for keeping fluid tightness, and hence, it is difficult to completely prevent the fluid leaking. In addition, the rotary actuator disclosed in the Patent Publication 1 has a complicated structure, so that the rotary actuator has itself a large size, thus being disadvantageous.

Furthermore, in the rotary actuator used for the stabilizer disclosed in the Patent Publication 2, since the screw grooves (threads) having the same lead are formed to the paired rotation shafts, the rotating torque is converted into thrust as it is, and accordingly, in order to receive a large rotating torque, it is necessary to make large, in size, constitutional members such as piston and rotational shaft. This matter indicates that the rotating torque and the thrust provide a worse conversion efficiency, and it has been required to provide a rotary actuator having a preferred conversion efficiency (for example, capable of converting a large rotating torque to a small thrust and generating a large rotating torque with a small thrust).

The present invention was conceived in consideration of the above circumstances and an object thereof is to provide a speed change mechanism or rotary actuator which have a high conversion efficiency between the rotating torque and the thrust, have a compact structure, and have an improved reliability attained by a high sealing performance, in comparison with a conventional rotary actuator.

### Means for Solving the Problem

The speed change mechanism according to the present invention includes: a pair of screw shafts disposed separately in a state in which rotating axes thereof are aligned on a same line and having outer peripheral surfaces in which spiral screw grooves are formed, respectively; and a nut member formed, in an inner peripheral surface thereof, with two kinds of nut grooves corresponding respectively to the screw grooves formed to the paired screw shafts so as to be engaged therewith, respectively, wherein a lead of the screw groove formed to one of the screw shafts and a lead of the screw groove formed to the other one of the screw shafts differ from each other.

The rotary actuator according to the present invention includes: a pair of screw shafts disposed separately in a state in which rotating axes thereof are aligned on a same line and having outer peripheral surfaces in which spiral screw grooves are formed, respectively; and a nut member formed, in an inner peripheral surface thereof, with two kinds of nut grooves corresponding respectively to the screw grooves formed to the paired screw shafts so as to be engaged therewith, respectively, wherein a lead of the screw groove formed to one of the screw shafts and a lead of the screw groove formed to the other one of the screw shafts differ from each other.

In the rotary actuator of the present invention, it may be preferred that a pair of the screw shafts and the nut member are engaged with each other through a plurality of rolling members disposed between the screw grooves and the nut grooves.

A rotary actuator according to another aspect of the present invention includes: a housing; a first screw shaft fixedly provided for one end side of the housing and formed, in an outer peripheral surface, with a spiral screw groove; a second screw shaft provided to be rotatable around an axis thereof in a manner of restricting a movement in the axial direction on another end side of the housing and formed, in an outer peripheral surface thereof, with a spiral screw groove; and a nut member formed, in an inner peripheral surface thereof, with two kinds of nut grooves corresponding respectively to the screw grooves formed to the first and second screw shafts so as to be engaged therewith, respectively, wherein the nut member is provided with a flanged portion which divides a space between the nut member and the housing into two operating fluid chambers, the housing is formed with a pair of operating fluid ports for flowing the operating fluid in or out of the two operating fluid chambers, and a lead of the screw groove formed to the first screw shaft is larger than a lead of the screw groove formed to the second screw shaft.

In the rotary actuator of this aspect, it may be preferred that the first and second screw shafts and the nut member are engaged through a plurality of rolling members disposed between the screw grooves and the nut groove.

Furthermore, in the rotary actuator of this aspect, it may be preferred that the housing has an outer configuration formed into a cylindrical shape.

Still furthermore, in the rotary actuator of this aspect, it may be preferred that the two operating fluid chambers are sealed by an oil seal disposed between the housing and the nut member.

Still furthermore, in the rotary actuator of this aspect, it may be preferred that the housing and the second screw shaft are disposed to be relatively rotatable through a rotary bearing mechanism, and the rotary bearing mechanism includes an outer race disposed on the housing side and formed, in an inner peripheral surface thereof, with an outer side rolling groove, an inner side rolling groove formed in an outer peripheral surface of the second screw shaft, and a plurality of rolling members disposed, to be rotatable, between the outer side rolling groove and the inner side rolling groove.

Further, it is to be noted that the above aspects of the present invention do not disclose all the essential features of the present invention, and accordingly, sub-combination of these features may constitute the present invention.

### EFFECTS OF THE INVENTION

According to the present invention, there is provided a speed change mechanism and rotary actuator having high conversion efficiency between the rotating torque and the thrust, having a compact structure of a system, and having a high sealing performance to thereby improve reliability of the system.

### BRIEF DESCRIPTION OF THE DRAWINGS

FIG. 1 is a partially sectional perspective view showing an entire structure of a rotary actuator according to one embodiment of the present invention.

FIG. 2 is a longitudinal sectional side view of the rotary actuator shown in FIG. 1.

FIG. 3 is a modelled view simply showing the structure of the rotary actuator according to the embodiment.

FIG. 4 is an illustration of a stabilizer to which the rotary actuator of the present embodiment is applied.

FIG. 5 is a partially sectional perspective view showing a modification of a rotary actuator according to one embodiment of the present invention.

FIG. 6 is a longitudinal sectional side view of the rotary actuator shown in FIG. 5.

### REFERENCE NUMERAL

10—rotary actuator, 11—first screw shaft, 12—screw groove (thread), 21—second screw shaft, 21a—inside rolling groove, 22—screw groove (thread), 30—nut member, 31, 32—nut groove, 35—flanged portion, 40—housing, 41—rotary bearing, 45, 46—operating fluid chamber, 45a, 46a—operating fluid port, 47—ball, 48—oil seal, 50—stabilizer, 60—rotary bearing mechanism, 61—outer race, 61a—outer rolling groove, 65—ball.

### BEST MODE FOR EMBODYING THE INVENTION

Hereunder, a preferred embodiment for carrying out the present invention will be described with reference to the accompanying drawings. Further, it is to be noted that the following embodiment does not limit the invention of the respective claims, and all the combination of subject features described in the embodiment is not essential for the solution of the invention. Furthermore, in the following embodiment, an example in which the present invention is constituted as a rotary actuator is shown, but the present invention may be applied various modes of the rotary actuator constituted as speed change mechanism. Still furthermore, the speed change mechanism or rotary actuator of the present invention is not one which is necessarily provided with a hydraulic source or power source explained in the embodiment mentioned hereinlater and includes a structure constituted as a part provided with no driving source assembled to an apparatus. It is of course apparent that the present invention is applicable to one provided with a structure defined in the appended patent claims.

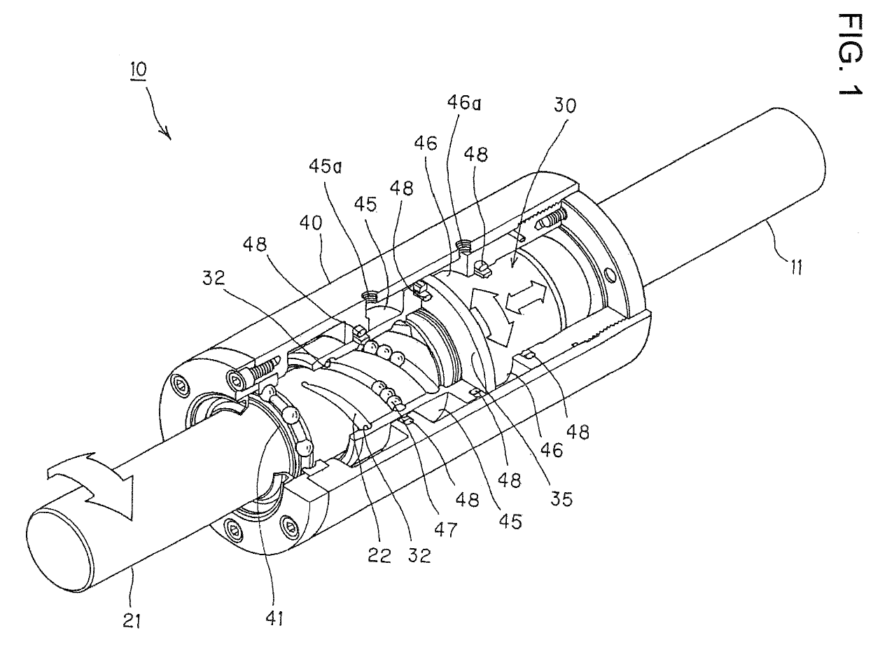

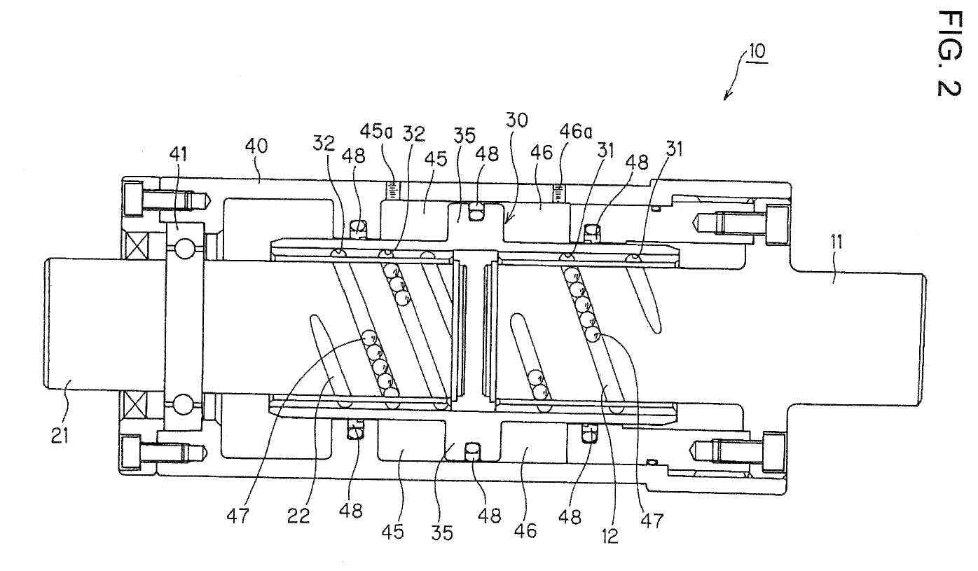

FIG. 1 is a partially sectional perspective view showing an entire structure of a rotary actuator according to the present embodiment. FIG. 2 is a longitudinal sectional view showing the rotary actuator shown in FIG. 1.

A rotary actuator 10 according to the present embodiment includes, as main constitutional members, a housing 40, a first screw shaft 11, a second screw shaft 21 and a nut member 30, which are provided for the housing 40. The housing 40 is a member having substantially cylindrical outer configuration and forms a compact outer configuration as rotary actuator itself. The cylindrical outer configuration of the housing 40 contributes to the improvement of a sealing performance of the operating fluid chambers 45, 46 and to the operation with reduced amount of operating oil.

The first screw shaft 11 is a shaft member formed, on its outer peripheral surface, with a spiral screw groove 12 (thread) and is fixedly arranged on one end side (right side on the drawing paper) of the housing 40. On the other hand, the second screw shaft 21 is a shaft member as like as the first screw shaft 11 formed, on its outer peripheral surface, with a spiral screw groove 22 (thread) and is connected to the other end side (left side on the drawing paper) of the housing 40 through a rotary bearing 41. Accordingly, the second screw shaft 21 is arranged to be rotatable with the axis of the second screw shaft 21 being the rotation center in a state of restricting the movement in the axial direction thereof. Further, the first and second screw shafts 11 and 21 are disposed in such a positional relationship that they are separated but aligned on the same rotation axis line.

The nut member 30 has substantially a cylindrical outer configuration and is provided, at a central portion in the cylindrical shape, with a flanged portion 35 projected outward in the circumferential direction. The flanged portion 35 serves to separate a space between the nut member 30 and the housing 40 into two operating fluid chambers 45 and 46. Furthermore, the nut member 30 is formed, at its inner peripheral surface, with two kinds of nut grooves 31 and 32 corresponding to the screw grooves 12 and 22 formed to the first and second screw shafts 11 and 21, respectively. The nut groove 31 and the screw groove 12 of the first screw shaft 11 are engaged with each other through a plurality of balls 47, and on the other hand, the nut groove 32 and the screw groove 22 of the second screw shaft 21 are also engaged with each other through a plurality of balls 47. Accordingly, when a rotating torque is applied to the second screw shaft 21, the nut member 30 is reciprocally moved in the axial direction while rotating, and the existence of a plurality of balls 47 makes it possible to perform smooth rotating and reciprocating motions of the nut member 30.

In addition, two operating fluid chambers 45 and 46 formed by the housing 40 and the nut member 30 are communicated with each other so that the operating fluid is flowed or discharged in or out through a pair of operating fluid ports 45a and 46a formed to the housing 40. Accordingly, when both the operating fluid ports 45a and 46a are closed, the movement of the nut member 30 is restricted, and when the fluid is allowed to be flowed in or out through the operating fluid ports 45a and 46a, the nut member 30 becomes movable. Further, two operating fluid chambers 45 and 46 are surely sealed by an oil seal disposed between the housing 40a and the nut member 30, so that the leaking of the fluid from the operating fluid chambers 45 and 46 can be prevented, and in addition, the fluid tight condition in the operating fluid chambers 45 and 46 can be surely maintained.

Hereinbefore, although the basic structure of the rotary actuator 10 according to the present embodiment was described, the rotary actuator 10 of the present embodiment has a further feature such that a lead formed to one screw shaft and a lead formed to the other screw shaft are formed differently from each other. More specifically, the rotary actuator 10 represented in FIGS. 1 and 2 has a structure in which the lead of the screw groove 12 formed to the first screw shaft 11 is larger than the lead of the screw groove 22 of the second screw shaft 21. According to such construction of the rotary actuator 10, it becomes possible to provide a rotary actuator having high conversion efficiency between the rotating torque and the thrust.

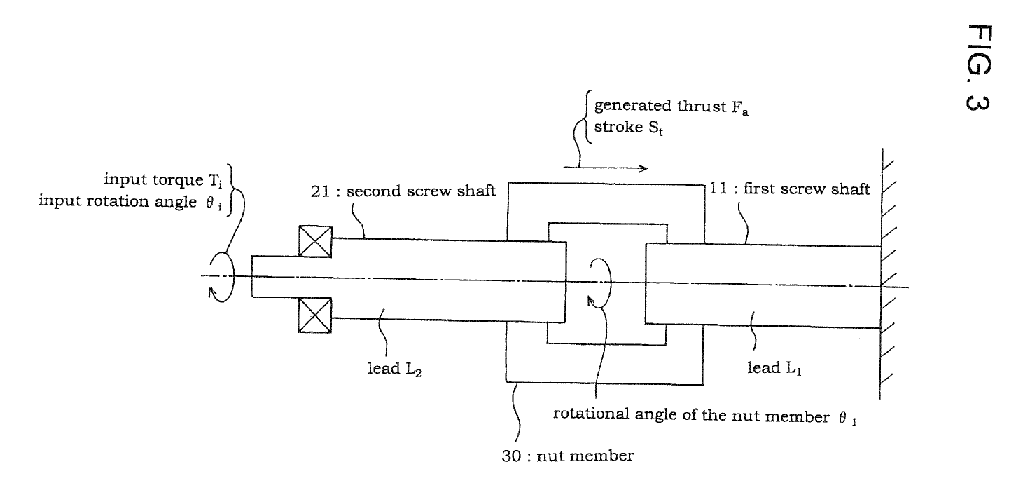

The principle of improving the conversion efficiency between the rotating torque and the thrust will be explained with reference to FIG. 3, which is a modelled view simply illustrating the structure of the rotary actuator of the present embodiment.

A stroke Sₜ₂ of the nut member in a case when an input rotation angle θᵢ is applied with respect to the second screw shaft 21 will be shown by the following Equation (1).

$${S}_{t 2} = \frac{{θ}_{i}}{360} \times {L}_{2} \qquad [ Equation 1 ]$$

Further, supposing that the rotation angle at the time when the nut member 30 is moved by an amount corresponding to the stroke represented by the Equation (1) is θ₁, a stroke amount Sₜ₁ corresponding to this rotational angle θ₁ is generated to the nut member 30 with respect to the first screw shaft 11. The stroke Sₜ₁ is represented by the following Equation (2).

$${S}_{t 1} = \frac{{θ}_{1}}{360} \times {L}_{1} \qquad [ Equation 2 ]$$

As shown in the Equation (2), when the nut member 30 is rotated by the rotational angle θ₁, a stroke with respect to the second screw shaft 21 is applied to the nut member 30. The stroke Sₜ₂ is represented by the following Equation (3).

$${S}_{t {2}^{′}} = \frac{{θ}_{1}}{360} \times {L}_{2} \qquad [ Equation 3 ]$$

The stroke Sₜ of the nut member 30 is equal to the sum of the stroke amounts with respect to the first and second screw shafts 11 and 21, so that the following Equation (4) is established.

$${S}_{t} = {S}_{t 2} + {S}_{t {2}^{′}} = {S}_{t 1} \\ \frac{{θ}_{i}}{360} \times {L}_{2} + \frac{{θ}_{1}}{360} \times {L}_{2} = \frac{{θ}_{1}}{360} \times {L}_{1} \\ \frac{{θ}_{i} + {θ}_{1}}{360} \times {L}_{2} = \frac{{θ}_{1}}{360} \times {L}_{1} \qquad [ Equation 4 ]$$

Then, according to the Equation (4), the following Equation (5) will be established.

$$\frac{{θ}_{i} + {θ}_{1}}{360} \times {L}_{2} = \frac{{θ}_{1}}{360} \times {L}_{1} \\ ( {θ}_{i} + {θ}_{1} ) \times {L}_{2} = {θ}_{1} \times {L}_{1} \\ {θ}_{i} \times {L}_{2} + {θ}_{1} \times {L}_{2} = {θ}_{1} \times {L}_{1} \\ {θ}_{i} \times {L}_{2} = {θ}_{1} \times ( {L}_{1} - {L}_{2} ) \\ {θ}_{i} : {θ}_{1} = ( {L}_{1} - {L}_{2} ) : {L}_{2} \qquad [ Equation 5 ]$$

Next, a virtual lead calculation is performed. Herein, the virtual lead means a lead, which is virtually calculated with a standard of the trust of the nut member 30 generated by the combination of the lead L₁ of the first screw shaft 11 and the lead L₂ of the second screw shaft 21. In the rotary actuator 10 of the present embodiment, by the effect caused by the combination of the lead L₁ of the first screw shaft 11 and the lead L₂ of the second screw shaft 21, the nut member 30 can perform an operation based on a large (virtual) lead which is not expected to be realized in a general working technology.

First, supposing that the lead L₁ of the first screw shaft as anti-input shaft is “a” and the lead L₂ of the second screw shaft 21 as input shaft is “b”, the following Equations (6) and (7) will be established from the Equation (5).

$$\begin{matrix}{θ}_{1} = \frac{{L}_{2}}{{L}_{1} - {L}_{2}} \times {θ}_{i} = \frac{b}{a - b} \times {θ}_{i} \\ {L}_{1} = \frac{a}{b} \times {L}_{2} & [ Equation 6 ] \\ {S}_{t 2} = \frac{{θ}_{i}}{360} \times {L}_{2} \\ {S}_{t {2}^{′}} = \frac{{θ}_{1}}{360} \times {L}_{2} = \frac{b}{a - b} \times {θ}_{i} \times {L}_{2} \div 360 \\ {S}_{t 1} = \frac{{θ}_{1}}{360} \times {L}_{1} = \frac{b}{a - b} \times {θ}_{i} \times \frac{a}{b} \times {L}_{2} \div 360 \\ = \frac{a}{a - b} \times {θ}_{i} \times {L}_{2} \div 360 & [ Equation 7 ]\end{matrix}$$

Furthermore, the following Equations (8) and (9) will be also established.

$$\begin{matrix}\begin{matrix}{S}_{t 2} + {S}_{t {2}^{′}} = \frac{{θ}_{i}}{360} \times {L}_{2} + \frac{b}{a - b} \times {θ}_{i} \times {L}_{2} \div 360 \\ = \frac{{θ}_{i}}{360} \times {L}_{2} \times ( 1 + \frac{b}{a - b} ) \\ = \frac{{θ}_{i}}{360} \times {L}_{2} \times ( \frac{a}{a - b} )\end{matrix} & [ Equation 8 ] \\ {S}_{t} = {S}_{t 2} + {S}_{t {2}^{′}} = {S}_{t 1} & [ Equation 9 ]\end{matrix}$$

Accordingly, the virtual lead Lₖ is represented as the following Equation (10) with θⁱ=α.

$${S}_{t} = \frac{α}{360} {L}_{k} = {S}_{t 2} + {S}_{t {2}^{′}} \\ \begin{matrix}{L}_{k} = \frac{( {S}_{t 2} + {S}_{t {2}^{′}} ) \times 360}{α} \\ = \frac{( \frac{a}{a - b} ) \times α \times {L}_{2} \div 360 \times 360}{α} \\ = \frac{a \times b}{a - b} ( = \frac{{L}_{1} \times {L}_{2}}{{L}_{1} - {L}_{2}} )\end{matrix} \qquad [ Equation 10 ]$$

Herein, it may be considered, as a measure for making large the virtual lead Lₖ, that the value of denominator (a-b) in the Equation (10) is made small. That is, it becomes necessary for the value “a” as the lead L₁ of the first screw shaft 11 to approach, as near as possible, the value “b” as the lead L₂ of the second screw shaft 21. However, in a case when “a” approaches nearly “b” (a≈b), a rotating member will frequently slides, and therefore, a caution may be required.

On the basis of the above principle, the leads of the first screw shaft 11 and second screw shaft 21, in a case of “a:b” being a constant ratio, are respectively obtained, and the obtained value is replaced to the virtual lead. Then, the trust generated at this time to the nut member 30 is described on the following Tables 1 to 9. Further, in the following Tables 1 to 9, the diameter of the screw shaft is supposed to be “^{φ}35”, and the maximum lead Lₘₐₓ is supposed to be Lₘₐₓ=3×d=105 mm.

Moreover, the leads of the respective screw shafts are represented as the following Equation (11) to thereby the Leads L₁ and L₂ are obtained.

L₁=f×L₂(f>1 coefficient) [Equation 11]

Furthermore, the virtual lead Lₖ is obtained from the following Equation (12).

$${L}_{k} = \frac{{L}_{1} \times {L}_{2}}{{L}_{1} - {L}_{2}} \qquad [ Equation 12 ]$$

Still furthermore, generation thrust Fₐ at the virtual lead Lₖ is obtained by the following Equation (13).

$${F}_{a} = \frac{2 π \times η \times T}{{L}_{k}} = \frac{2 π \times 0.9 \times 1324 \times 0.102 \times 1000}{{L}_{k}} \qquad [ Equation 13 ]$$

Further, pressure receiving areas (both p=9.3 Mpa and p=20 Mpa) at the obtained generation thrusts are obtained from the following Equation (14).

$${A}_{93} = \frac{{F}_{a} \div 0.102}{9.3} [ {mm}^{2} ] , {}_{}^{φ}{D}{}_{9.3}^{} = \sqrt{\frac{4 \times {A}_{9.3}}{π}} [ mm ] \\ {A}_{20} = \frac{{F}_{a} \div 0.102}{20} [ {mm}^{2} ] , {}_{}^{φ}{D}{}_{20}^{} = \sqrt{\frac{4 \times {A}_{20}}{π}} [ mm ] \qquad [ Equation 14 ]$$

TABLE 1
(f = 1.1)

| | | | | pressure | |
|---|---|---|---|---|---|
| | | virtual | general | receiving | diameter of |
| lead L₂ | lead L₁ | lead | thrust | area A [mm²] | section D [mm] |
| [mm] | [mm] | Lₖ [mm] | Fₐ [kgf] | (A_{9.8}/A₂₀) | (^{φ}D_{9.8}/^{φ}D₂₀) |
| 5 | 5.5 | 55 | 13885 | 14637.0 | 136.5 |
| | | | | 6806.2 | 93.1 |
| 10 | 11.0 | 110 | 6942 | 7318.5 | 96.5 |
| | | | | 3403.1 | 65.8 |
| 15 | 16.5 | 165 | 4628 | 4879.0 | 78.8 |
| | | | | 2268.7 | 53.7 |
| 20 | 22.0 | 220 | 3471 | 3659.2 | 68.3 |
| | | | | 1701.6 | 46.5 |
| 25 | 27.5 | 275 | 2777 | 2927.4 | 61.1 |
| | | | | 1361.2 | 41.6 |
| 30 | 33.0 | 330 | 2314 | 2439.5 | 55.7 |
| | | | | 1134.4 | 38.0 |
| 35 | 38.5 | 385 | 1984 | 2091.0 | 51.6 |
| | | | | 972.3 | 35.2 |
| 40 | 44.0 | 440 | 1736 | 1829.6 | 48.3 |
| | | | | 850.8 | 32.9 |
| 45 | 49.5 | 495 | 1543 | 1626.3 | 45.5 |
| | | | | 756.2 | 31.0 |
| 50 | 55.0 | 550 | 1388 | 1463.7 | 43.2 |
| | | | | 680.6 | 29.4 |
| 55 | 60.5 | 605 | 1262 | 1330.6 | 41.2 |
| | | | | 618.7 | 28.1 |
| 60 | 66.0 | 660 | 1157 | 1219.7 | 39.4 |
| | | | | 567.2 | 26.9 |
| 65 | 71.5 | 715 | 1068 | 1125.9 | 37.9 |
| | | | | 523.6 | 25.8 |
| 70 | 77.0 | 770 | 992 | 1045.5 | 36.5 |
| | | | | 486.2 | 24.9 |
| 75 | 82.5 | 825 | 926 | 975.8 | 35.2 |
| | | | | 453.7 | 24.0 |
| 80 | 88.0 | 880 | 868 | 914.8 | 34.1 |
| | | | | 425.4 | 23.3 |
| 85 | 93.5 | 935 | 817 | 861.0 | 33.1 |
| | | | | 400.4 | 22.6 |
| 90 | 99.0 | 990 | 771 | 813.2 | 32.2 |
| | | | | 378.1 | 21.9 |
| 95 | 104.5 | 1045 | 731 | 770.4 | 31.3 |
| | | | | 358.2 | 21.4 |

TABLE 2
(f = 1.2)

| | | | | pressure | |
|---|---|---|---|---|---|
| | | virtual | general | receiving | diameter of |
| lead L₂ | lead L₁ | lead | thrust | area A [mm²] | section D [mm] |
| [mm] | [mm] | Lₖ [mm] | Fₐ [kgf] | (A_{9.8}/A₂₀) | (^{φ}D_{9.8}/^{φ}D₂₀) |
| 5 | 6.0 | 30 | 25455 | 26834.5 | 184.8 |
| | | | | 12478.0 | 126.0 |
| 10 | 12.0 | 60 | 12728 | 13417.2 | 130.7 |
| | | | | 6239.0 | 89.1 |
| 15 | 18.0 | 90 | 8485 | 8944.8 | 106.7 |
| | | | | 4159.3 | 72.8 |
| 20 | 24.0 | 120 | 6364 | 6708.6 | 92.4 |
| | | | | 3119.5 | 63.0 |
| 25 | 30.0 | 150 | 5091 | 5366.9 | 82.7 |
| | | | | 2495.6 | 56.4 |
| 30 | 36.0 | 180 | 4243 | 4472.4 | 75.5 |
| | | | | 2079.7 | 51.5 |
| 35 | 42.0 | 210 | 3636 | 3833.5 | 69.9 |
| | | | | 1782.6 | 47.6 |
| 40 | 48.0 | 240 | 3182 | 3354.3 | 65.4 |
| | | | | 1559.8 | 44.6 |
| 45 | 54.0 | 270 | 2828 | 2981.6 | 61.6 |
| | | | | 1386.4 | 42.0 |
| 50 | 60.0 | 300 | 2546 | 2683.4 | 58.5 |
| | | | | 1247.8 | 39.9 |
| 55 | 66.0 | 330 | 2314 | 2439.5 | 55.7 |
| | | | | 1134.4 | 38.0 |
| 60 | 72.0 | 360 | 2121 | 2236.2 | 53.4 |
| | | | | 1039.8 | 36.4 |
| 65 | 78.0 | 390 | 1958 | 2064.2 | 51.3 |
| | | | | 959.8 | 35.0 |
| 70 | 84.0 | 420 | 1818 | 1916.7 | 49.4 |
| | | | | 891.3 | 33.7 |
| 75 | 90.0 | 450 | 1697 | 1789.0 | 47.7 |
| | | | | 831.9 | 32.5 |
| 80 | 96.0 | 480 | 1591 | 1677.2 | 46.2 |
| | | | | 779.9 | 31.5 |
| 85 | 102.0 | 510 | 1497 | 1578.5 | 44.8 |
| | | | | 734.0 | 30.6 |
| 90 | 108.0 | 540 | 1414 | 1490.8 | 43.6 |
| | | | | 693.2 | 29.7 |
| 95 | 114.0 | 570 | 1340 | 1412.3 | 42.4 |
| | | | | 656.7 | 28.9 |

TABLE 3
(f = 1.3)

| | | | | pressure | |
|---|---|---|---|---|---|
| | | virtual | general | receiving | diameter of |
| lead L₂ | lead L₁ | lead | thrust | area A [mm²] | section D [mm] |
| [mm] | [mm] | Lₖ [mm] | Fₐ [kgf] | (A_{9.8}/A₂₀) | (^{φ}D_{9.8}/^{φ}D₂₀) |
| 5 | 6.5 | 22 | 35246 | 37155.4 | 217.5 |
| | | | | 17277.3 | 148.3 |
| 10 | 13.0 | 43 | 17623 | 18577.7 | 153.8 |
| | | | | 8638.6 | 104.9 |
| 15 | 19.5 | 65 | 11749 | 12385.1 | 125.6 |
| | | | | 5759.1 | 85.6 |
| 20 | 26.0 | 87 | 8811 | 9288.9 | 108.8 |
| | | | | 4319.3 | 74.2 |
| 25 | 32.5 | 108 | 7049 | 7431.1 | 97.3 |
| | | | | 3455.5 | 66.3 |
| 30 | 39.0 | 130 | 5874 | 6192.6 | 88.8 |
| | | | | 2879.5 | 60.6 |
| 35 | 45.5 | 152 | 5035 | 5307.9 | 82.2 |
| | | | | 2468.2 | 56.1 |
| 40 | 52.0 | 173 | 4406 | 4644.4 | 76.9 |
| | | | | 2159.7 | 52.4 |
| 45 | 58.5 | 195 | 3916 | 4128.4 | 72.5 |
| | | | | 1919.7 | 49.4 |
| 50 | 65.0 | 217 | 3525 | 3715.5 | 68.8 |
| | | | | 1727.7 | 46.9 |
| 55 | 71.5 | 238 | 3204 | 3377.8 | 65.6 |
| | | | | 1570.7 | 44.7 |
| 60 | 78.0 | 260 | 2937 | 3096.3 | 62.8 |
| | | | | 1439.8 | 42.8 |
| 65 | 84.5 | 282 | 2711 | 2858.1 | 60.3 |
| | | | | 1329.0 | 41.1 |
| 70 | 91.0 | 303 | 2518 | 2654.0 | 58.1 |
| | | | | 1234.1 | 39.6 |
| 75 | 97.5 | 325 | 2350 | 2477.0 | 56.2 |
| | | | | 1151.8 | 38.3 |
| 80 | 104.0 | 347 | 2203 | 2322.2 | 54.4 |
| | | | | 1079.8 | 37.1 |
| 85 | 110.5 | 368 | 2073 | 2185.6 | 52.8 |
| | | | | 1016.3 | 36.0 |
| 90 | 117.0 | 390 | 1958 | 2064.2 | 51.3 |
| | | | | 959.8 | 35.0 |
| 95 | 123.5 | 412 | 1855 | 1955.5 | 49.9 |
| | | | | 909.3 | 34.0 |

TABLE 4
(f = 1.4)

| | | | | pressure | |
|---|---|---|---|---|---|
| | | virtual | general | receiving | diameter of |
| lead L₂ | lead L₁ | lead | thrust | area A [mm²] | section D [mm] |
| [mm] | [mm] | Lₖ [mm] | Fₐ [kgf] | (A_{9.8}/A₂₀) | (^{φ}D_{9.8}/^{φ}D₂₀) |
| 5 | 7.0 | 18 | 43637 | 46002.0 | 242.0 |
| | | | | 21390.9 | 165.0 |
| 10 | 14.0 | 35 | 21819 | 23001.0 | 171.1 |
| | | | | 10695.5 | 116.7 |
| 15 | 21.0 | 53 | 14546 | 15334.0 | 139.7 |
| | | | | 7130.3 | 95.3 |
| 20 | 28.0 | 70 | 10909 | 11500.5 | 121.0 |
| | | | | 5347.7 | 82.5 |
| 25 | 35.0 | 88 | 8727 | 9200.4 | 108.2 |
| | | | | 4278.2 | 73.8 |
| 30 | 42.0 | 105 | 7273 | 7667.0 | 98.8 |
| | | | | 3565.2 | 67.4 |
| 35 | 49.0 | 123 | 6234 | 6571.7 | 91.5 |
| | | | | 3055.8 | 62.4 |
| 40 | 56.0 | 140 | 5455 | 5750.2 | 85.6 |
| | | | | 2673.9 | 58.3 |
| 45 | 63.0 | 158 | 4849 | 5111.3 | 80.7 |
| | | | | 2376.8 | 55.0 |
| 50 | 70.0 | 175 | 4364 | 4600.2 | 76.5 |
| | | | | 2139.1 | 52.2 |
| 55 | 77.0 | 193 | 3967 | 4182.0 | 73.0 |
| | | | | 1944.6 | 49.8 |
| 60 | 84.0 | 210 | 3636 | 3833.5 | 69.9 |
| | | | | 1782.6 | 47.6 |
| 65 | 91.0 | 228 | 3357 | 3538.6 | 67.1 |
| | | | | 1645.5 | 45.8 |
| 70 | 98.0 | 245 | 3117 | 3285.9 | 64.7 |
| | | | | 1527.9 | 44.1 |
| 75 | 105.0 | 263 | 2909 | 3066.8 | 62.5 |
| | | | | 1426.1 | 42.6 |
| 80 | 112.0 | 280 | 2727 | 2875.1 | 60.5 |
| | | | | 1336.9 | 41.3 |
| 85 | 119.0 | 298 | 2567 | 2706.0 | 58.7 |
| | | | | 1258.3 | 40.0 |
| 90 | 126.0 | 315 | 2424 | 2555.7 | 57.0 |
| | | | | 1188.4 | 38.9 |
| 95 | 133.0 | 333 | 2297 | 2421.2 | 55.5 |
| | | | | 1125.8 | 37.9 |

TABLE 5
(f = 1.5)

| | | | | pressure | |
|---|---|---|---|---|---|
| | | virtual | general | receiving | diameter of |
| lead L₂ | lead L₁ | lead | thrust | area A [mm²] | section D [mm] |
| [mm] | [mm] | Lₖ [mm] | Fₐ [kgf] | (A_{9.8}/A₂₀) | (^{φ}D_{9.8}/^{φ}D₂₀) |
| 5 | 7.5 | 15 | 50910 | 53669.0 | 261.4 |
| | | | | 24956.1 | 178.3 |
| 10 | 15.0 | 30 | 25455 | 26834.5 | 184.8 |
| | | | | 12478.0 | 126.0 |
| 15 | 22.5 | 45 | 16970 | 17889.7 | 150.9 |
| | | | | 8318.7 | 102.9 |
| 20 | 30.0 | 60 | 12728 | 13417.2 | 130.7 |
| | | | | 6239.0 | 89.1 |
| 25 | 37.5 | 75 | 10182 | 10733.8 | 116.9 |
| | | | | 4991.2 | 79.7 |
| 30 | 45.0 | 90 | 8485 | 8944.8 | 106.7 |
| | | | | 4159.3 | 72.8 |
| 35 | 52.5 | 105 | 7273 | 7667.0 | 98.8 |
| | | | | 3565.2 | 67.4 |
| 40 | 60.0 | 120 | 6364 | 6708.6 | 92.4 |
| | | | | 3119.5 | 63.0 |
| 45 | 67.5 | 135 | 5657 | 5963.2 | 87.1 |
| | | | | 2772.9 | 59.4 |
| 50 | 75.0 | 150 | 5091 | 5366.9 | 82.7 |
| | | | | 2495.6 | 56.4 |
| 55 | 82.5 | 165 | 4628 | 4879.0 | 78.8 |
| | | | | 2268.7 | 53.7 |
| 60 | 90.0 | 180 | 4243 | 4472.4 | 75.5 |
| | | | | 2079.7 | 51.5 |
| 65 | 97.5 | 195 | 3916 | 4128.4 | 72.5 |
| | | | | 1919.7 | 49.4 |
| 70 | 105.0 | 210 | 3636 | 3833.5 | 69.9 |
| | | | | 1782.6 | 47.6 |
| 75 | 112.5 | 225 | 3394 | 3577.9 | 67.5 |
| | | | | 1663.7 | 46.0 |
| 80 | 120.0 | 240 | 3182 | 3354.3 | 65.4 |
| | | | | 1559.8 | 44.6 |
| 85 | 127.5 | 255 | 2995 | 3157.0 | 63.4 |
| | | | | 1468.0 | 43.2 |
| 90 | 135.0 | 270 | 2828 | 2981.6 | 61.6 |
| | | | | 1386.4 | 42.0 |
| 95 | 142.5 | 285 | 2679 | 2824.7 | 60.0 |
| | | | | 1313.5 | 40.9 |

TABLE 6
(f = 1.6)

| | | | | pressure | |
|---|---|---|---|---|---|
| | | virtual | general | receiving | diameter of |
| lead L₂ | lead L₁ | lead | thrust | area A [mm²] | section D [mm] |
| [mm] | [mm] | Lₖ [mm] | Fₐ [kgf] | (A_{9.8}/A₂₀) | (^{φ}D_{9.8}/^{φ}D₂₀) |
| 5 | 8.0 | 13 | 57274 | 60377.6 | 277.3 |
| | | | | 28075.6 | 189.1 |
| 10 | 16.0 | 27 | 28637 | 30188.8 | 196.1 |
| | | | | 14037.8 | 133.7 |
| 15 | 24.0 | 40 | 19091 | 20125.9 | 160.1 |
| | | | | 9358.5 | 109.2 |
| 20 | 32.0 | 53 | 14319 | 15094.4 | 138.6 |
| | | | | 7018.9 | 94.5 |
| 25 | 40.0 | 67 | 11455 | 12075.5 | 124.0 |
| | | | | 5615.1 | 84.6 |
| 30 | 48.0 | 80 | 9546 | 10062.9 | 113.2 |
| | | | | 4679.3 | 77.2 |
| 35 | 56.0 | 93 | 8182 | 8625.4 | 104.8 |
| | | | | 4010.8 | 71.5 |
| 40 | 64.0 | 107 | 7159 | 7547.2 | 98.0 |
| | | | | 3509.4 | 66.8 |
| 45 | 72.0 | 120 | 6364 | 6708.6 | 92.4 |
| | | | | 3119.5 | 63.0 |
| 50 | 80.0 | 133 | 5727 | 6037.8 | 87.7 |
| | | | | 2807.6 | 59.8 |
| 55 | 88.0 | 147 | 5207 | 5488.9 | 83.6 |
| | | | | 2552.3 | 57.0 |
| 60 | 96.0 | 160 | 4773 | 5031.5 | 80.0 |
| | | | | 2339.6 | 54.6 |
| 65 | 104.0 | 173 | 4406 | 4644.4 | 76.9 |
| | | | | 2159.7 | 52.4 |
| 70 | 112.0 | 187 | 4091 | 4312.7 | 74.1 |
| | | | | 2005.4 | 50.5 |
| 75 | 120.0 | 200 | 3818 | 4025.2 | 71.6 |
| | | | | 1871.7 | 48.8 |
| 80 | 128.0 | 213 | 3580 | 3773.6 | 69.3 |
| | | | | 1754.7 | 47.3 |
| 85 | 136.0 | 227 | 3369 | 3551.6 | 67.2 |
| | | | | 1651.5 | 45.9 |
| 90 | 144.0 | 240 | 3182 | 3354.3 | 65.4 |
| | | | | 1559.8 | 44.6 |
| 95 | 152.0 | 253 | 3014 | 3177.8 | 63.6 |
| | | | | 1477.7 | 43.4 |

TABLE 7
(f = 1.7)

| | | | | pressure | |
|---|---|---|---|---|---|
| | | virtual | general | receiving | diameter of |
| lead L₂ | lead L₁ | lead | thrust | area A [mm²] | section D [mm] |
| [mm] | [mm] | Lₖ [mm] | Fₐ [kgf] | (A_{9.8}/A₂₀) | (^{φ}D_{9.8}/^{φ}D₂₀) |
| 5 | 8.5 | 12 | 62889 | 66297.0 | 290.5 |
| | | | | 30828.1 | 198.1 |
| 10 | 17.0 | 24 | 31445 | 33148.5 | 205.4 |
| | | | | 15414.0 | 140.1 |
| 15 | 25.5 | 36 | 20963 | 22099.0 | 167.7 |
| | | | | 10276.0 | 114.4 |
| 20 | 34.0 | 49 | 15722 | 16574.2 | 145.3 |
| | | | | 7707.0 | 99.1 |
| 25 | 42.5 | 61 | 12578 | 13259.4 | 129.9 |
| | | | | 6165.6 | 88.6 |
| 30 | 51.0 | 73 | 10482 | 11049.5 | 118.6 |
| | | | | 5138.0 | 80.9 |
| 35 | 59.5 | 85 | 8984 | 9471.0 | 109.8 |
| | | | | 4404.0 | 74.9 |
| 40 | 68.0 | 97 | 7861 | 8287.1 | 102.7 |
| | | | | 3853.5 | 70.0 |
| 45 | 76.5 | 109 | 6988 | 7366.3 | 96.8 |
| | | | | 3425.3 | 66.0 |
| 50 | 85.0 | 121 | 6289 | 6629.7 | 91.9 |
| | | | | 3082.8 | 62.7 |
| 55 | 93.5 | 134 | 5717 | 6027.0 | 87.6 |
| | | | | 2802.6 | 59.7 |
| 60 | 102.0 | 146 | 5241 | 5524.7 | 83.9 |
| | | | | 2569.0 | 57.2 |
| 65 | 110.5 | 158 | 4838 | 5099.8 | 80.6 |
| | | | | 2371.4 | 54.9 |
| 70 | 119.0 | 170 | 4492 | 4735.5 | 77.7 |
| | | | | 2202.0 | 53.0 |
| 75 | 127.5 | 182 | 4193 | 4419.8 | 75.0 |
| | | | | 2055.2 | 51.2 |
| 80 | 136.0 | 194 | 3931 | 4143.6 | 72.6 |
| | | | | 1926.8 | 49.5 |
| 85 | 144.5 | 206 | 3699 | 3899.8 | 70.5 |
| | | | | 1813.4 | 48.1 |
| 90 | 153.0 | 219 | 3494 | 3683.2 | 68.5 |
| | | | | 1712.7 | 46.7 |
| 95 | 161.5 | 231 | 3310 | 3489.3 | 66.7 |
| | | | | 1622.5 | 45.5 |

TABLE 8
(f = 1.8)

| | | | | pressure | |
|---|---|---|---|---|---|
| | | virtual | general | receiving | diameter of |
| lead L₂ | lead L₁ | lead | thrust | area A [mm²] | section D [mm] |
| [mm] | [mm] | Lₖ [mm] | Fₐ [kgf] | (A_{9.8}/A₂₀) | (^{φ}D_{9.8}/^{φ}D₂₀) |
| 5 | 9.0 | 11 | 67881 | 71558.6 | 301.9 |
| | | | | 33274.8 | 205.8 |
| 10 | 18.0 | 23 | 33940 | 35779.3 | 213.4 |
| | | | | 16637.4 | 145.5 |
| 15 | 27.0 | 34 | 22627 | 23852.9 | 174.3 |
| | | | | 11091.6 | 118.8 |
| 20 | 36.0 | 45 | 16970 | 17889.7 | 150.9 |
| | | | | 8318.7 | 102.9 |
| 25 | 45.0 | 56 | 13576 | 14311.7 | 135.0 |
| | | | | 6655.0 | 92.1 |
| 30 | 54.0 | 68 | 11313 | 11926.4 | 123.2 |
| | | | | 5545.8 | 84.0 |
| 35 | 63.0 | 79 | 9697 | 10222.7 | 114.1 |
| | | | | 4753.5 | 77.8 |
| 40 | 72.0 | 90 | 8485 | 8944.8 | 106.7 |
| | | | | 4159.3 | 72.8 |
| 45 | 81.0 | 101 | 7542 | 7951.0 | 100.6 |
| | | | | 3697.2 | 68.6 |
| 50 | 90.0 | 113 | 6788 | 7155.9 | 95.5 |
| | | | | 3327.5 | 65.1 |
| 55 | 99.0 | 124 | 6171 | 6505.3 | 91.0 |
| | | | | 3025.0 | 62.1 |
| 60 | 108.0 | 135 | 5657 | 5963.2 | 87.1 |
| | | | | 2772.9 | 59.4 |
| 65 | 117.0 | 146 | 5222 | 5504.5 | 83.7 |
| | | | | 2559.6 | 57.1 |
| 70 | 126.0 | 158 | 4849 | 5111.3 | 80.7 |
| | | | | 2376.8 | 55.0 |
| 75 | 135.0 | 169 | 4525 | 4770.6 | 77.9 |
| | | | | 2218.3 | 53.1 |
| 80 | 144.0 | 180 | 4243 | 4472.4 | 75.5 |
| | | | | 2079.7 | 51.5 |
| 85 | 153.0 | 191 | 3993 | 4209.3 | 73.2 |
| | | | | 1957.3 | 49.9 |
| 90 | 162.0 | 203 | 3771 | 3975.5 | 71.1 |
| | | | | 1848.6 | 48.5 |
| 95 | 171.0 | 214 | 3573 | 3766.2 | 69.2 |
| | | | | 1751.3 | 47.2 |

TABLE 9
(f = 1.9)

| | | | | pressure | |
|---|---|---|---|---|---|
| | | virtual | general | receiving | diameter of |
| lead L₂ | lead L₁ | lead | thrust | area A [mm²] | section D [mm] |
| [mm] | [mm] | Lₖ [mm] | Fₐ [kgf] | (A_{9.8}/A₂₀) | (^{φ}D_{9.8}/^{φ}D₂₀) |
| 5 | 9.5 | 11 | 72346 | 76266.4 | 311.6 |
| | | | | 35463.9 | 212.5 |
| 10 | 19.0 | 21 | 36173 | 38133.2 | 220.4 |
| | | | | 17731.9 | 150.3 |
| 15 | 28.5 | 32 | 24115 | 25422.1 | 179.9 |
| | | | | 11821.3 | 122.7 |
| 20 | 38.0 | 42 | 18087 | 19066.6 | 155.8 |
| | | | | 8866.0 | 106.2 |
| 25 | 47.5 | 53 | 14469 | 15253.3 | 139.4 |
| | | | | 7092.8 | 95.0 |
| 30 | 57.0 | 63 | 12058 | 12711.1 | 127.2 |
| | | | | 5910.6 | 86.8 |
| 35 | 66.5 | 74 | 10335 | 10895.2 | 117.8 |
| | | | | 5066.3 | 80.3 |
| 40 | 76.0 | 84 | 9043 | 9533.3 | 110.2 |
| | | | | 4433.0 | 75.1 |
| 45 | 85.5 | 95 | 8038 | 8474.0 | 103.9 |
| | | | | 3940.4 | 70.8 |
| 50 | 95.0 | 106 | 7235 | 7626.6 | 98.5 |
| | | | | 3546.4 | 67.2 |
| 55 | 104.5 | 116 | 6577 | 6933.3 | 94.0 |
| | | | | 3224.0 | 64.1 |
| 60 | 114.0 | 127 | 6029 | 6355.5 | 90.0 |
| | | | | 2955.3 | 61.3 |
| 65 | 123.5 | 137 | 5565 | 5866.6 | 86.4 |
| | | | | 2728.0 | 58.9 |
| 70 | 133.0 | 148 | 5168 | 5447.6 | 83.3 |
| | | | | 2533.1 | 56.8 |
| 75 | 142.5 | 158 | 4823 | 5084.4 | 80.5 |
| | | | | 2364.3 | 54.9 |
| 80 | 152.0 | 169 | 4522 | 4766.7 | 77.9 |
| | | | | 2216.5 | 53.1 |
| 85 | 161.5 | 179 | 4256 | 4486.3 | 75.6 |
| | | | | 2086.1 | 51.5 |
| 90 | 171.0 | 190 | 4019 | 4237.0 | 73.5 |
| | | | | 1970.2 | 50.1 |
| 95 | 180.5 | 201 | 3808 | 4014.0 | 71.5 |
| | | | | 1866.5 | 48.8 |

As is apparent from the above Tables 1 to 9, by forming the leads L₁ and L₂ having different sizes to the first and second screw shafts 11 and 21, the nut member 30 can perform driving operation based on the (virtual) lead far larger than the actual leads L₁ and L₂. Since such virtual lead is difficult to be realized in the existing working technology, according to the present invention, a quite new rotary actuator, which has not been realized in the conventional technology, can be provided.

The specific effects obtainable by the formation of the leads L₁ and L₂ having different sizes may include an effective performance of the conversion between the rotating torque and the thrust. For example, when a large rotating torque is applied to the second screw shaft 21 as an input shaft, due to the effect of the leads L₁ and L₂ having different sizes, the thrust caused to the nut member 30 becomes very small. This shows the fact that a reverse conversion is possible, and when a small thrust is applied to the nut member 30, it becomes possible to take out a very large rotating torque from the second screw shaft 21.

Next, the operation of the rotary actuator 10 according to the present embodiment will be described with reference to FIGS. 1 and 2.

When the rotating torque is applied to the second screw shaft 21 as an input shaft, according to the principle mentioned above, a force for generating a stroke with respect to the nut member 30 is applied. In this instance, the stroke of the nut member is enabled by making communicative the paired operating fluid ports 45a and 46a formed to the housing 40 with each other. For example, the nut member 30 is stroked toward the first screw shaft 11, the operating fluid is flowed into the operation chamber 45 through the operating fluid port 45a on the side of the second screw shaft 21 at a pair of the operating fluid ports 45a and 46a which are in fluid communicative condition, and on the other hand, the operating fluid in the other operating fluid chamber 46 is discharged through the operating fluid port 46a. According to such structure, a restricting force to the stroke operation of the nut member 30 does not act, so that the smooth stroke motion can be realized. Further, when the nut member 30 is stroked, the rotating torque applied to the second screw shaft 21 is converted into the thrust of the nut member 30, so that the power transmission such as rotating torque is shut off with respect to the first screw shaft 11.

On the other hand, in the case where a pair of operating fluid ports 45a and 46a are closed to thereby stop the flow-in or flow-out of the operating fluid through the operating fluid ports 45a and 46a, the operating fluids in the two operating fluid chambers 45 and 46 constitute resistance, which prevents the stroking motion of the nut member 30. Accordingly, the rotating torque which should be applied to the second screw shaft 21 is directly transmitted to the first screw shaft 11.

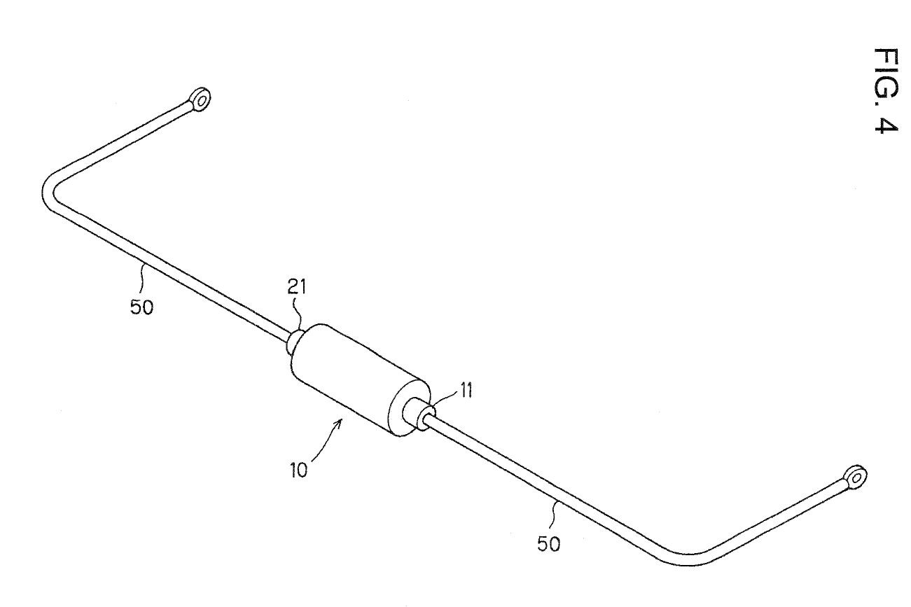

Hereinabove, the structure and the operation of the rotary actuator according to the present embodiment were described. Further, as a specific application of the rotary actuator of the present embodiment, an application to a stabilizer shown in FIG. 4 will be possible. In the rotary actuator 10 shown in FIG. 4, stabilizer bars 50 divided into two sections are mounted to the first and second screw shafts 11 and 21, respectively, and according to the operation control utilizing the above-mentioned paired operating fluid ports 45a and 46a, the divided stabilizer bars 50 are operated in the divided state or combined state.

The rotary actuator 10 according to the present embodiment serves to control the force applied externally such as rotating torque, and in addition, to generate the thrust to the nut member 30, for example, by positively rotating the second screw shaft 21 and to generate the rotating torque to the second screw shaft 21 by positively driving the nut member 30.

Hereinabove, although the preferred embodiment of the present invention was described, the technical scope of the present invention is not limited to the described range of the embodiment, and the above embodiment may include many changes and modifications.

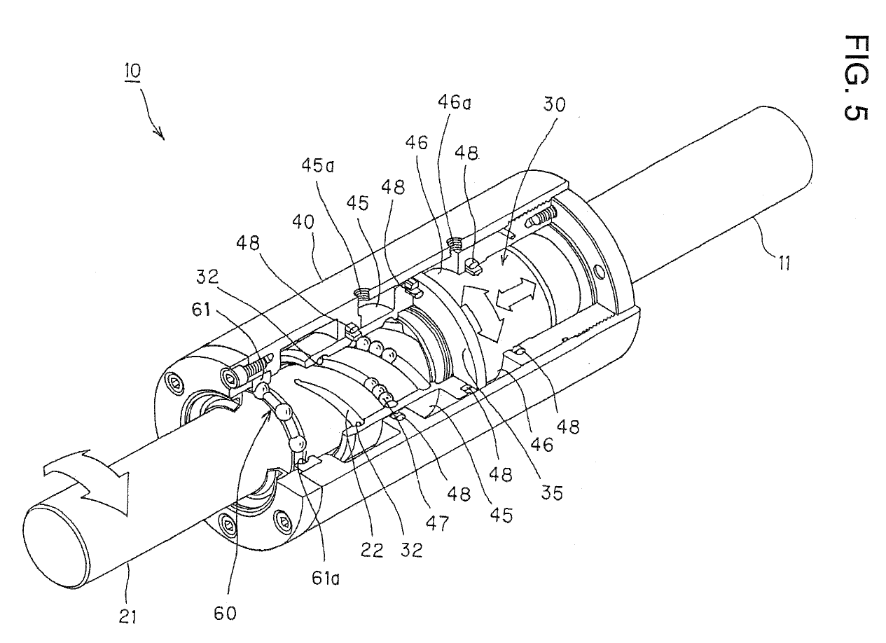

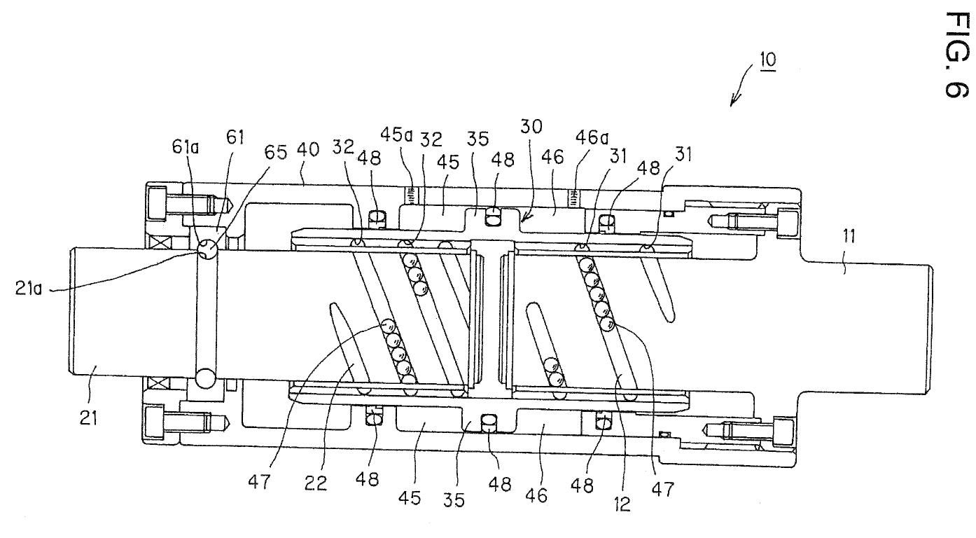

For example, with the rotary actuator 10 according to the present embodiment described with reference to FIGS. 1 and 2, there was described a case in which the housing 40 and the second screw shaft 21 are connected through the rotary bearing 41. However, as a connection method between the housing 40 and the second screw shaft 21, it may be possible, as shown in FIGS. 5 and 6, to connect the housing 40 and the second screw shaft 21 to be rotatably through the rotary bearing mechanism 60 in which an inner race of the rotary bearing 41 is eliminated. This rotary bearing mechanism 60 is disposed on the housing (40) side, and includes an outer race 61 formed, on an inner peripheral surface thereof, with an outer side rolling groove 61a, an inner side rolling groove 21a formed to an outer peripheral surface of the second screw shaft 21 and a plurality of balls 65 disposed to be rollable between the outer side rolling groove 61a and the inner side rolling groove 21a. According to such structure, it becomes possible to provide a compact rotary actuator with good performance being maintained.

Furthermore, in the rotary actuator according to the described embodiment, a pair of screw shafts 11 and 21 acting as driving section and the nut member 30 are covered by the housing 40, and the operation thereof is controlled by hydraulic pressure caused by the operating fluid. However, the present invention is not limited to such application, and for example, the housing 40 may be eliminated, and in such a case, the second screw shaft 21 and the nut member 30 are driven by an electric equipment such as electric motor, and a speed change mechanism may be adopted as means for converting the rotating torque to the thrust or changing the speeds thereof. Even in the speed change mechanism and the rotary actuator of such structures, it is possible to achieve the preferred effects of the present invention capable of effectively converting the rotating torque and the thrust.

Still furthermore, according to the rotary actuator of the present embodiment, there was described the case in which the balls 47 and 65 are used as rolling members utilized for realizing the smooth motion of the system. However, rollers may be utilized in place of the balls as the rolling members. Such modification of improved mode may be within the technical range of the present invention, which will be apparent from the scope of the appended claims.

1. A speed change mechanism comprising:
a pair of screw shafts disposed separately in a state in which rotating axes thereof are aligned on a same line and having outer peripheral surfaces in which spiral screw grooves are formed, respectively; and
a nut member formed, in an inner peripheral surface thereof, with two kinds of nut grooves corresponding respectively to the screw grooves formed to the paired screw shafts so as to be engaged therewith, respectively,
wherein a lead of the screw groove formed to one of the screw shafts and a lead of the screw groove formed to the other one of the screw shafts differ from each other.

2. A rotary actuator comprising:
a pair of screw shafts disposed separately in a state in which rotating axes thereof are aligned on a same line and having outer peripheral surfaces in which spiral screw grooves are formed, respectively; and
a nut member formed, in an inner peripheral surface thereof, with two kinds of nut grooves corresponding respectively to the screw grooves formed to the paired screw shafts so as to be engaged therewith, respectively,
wherein a lead of the screw groove formed to one of the screw shafts and a lead of the screw groove formed to the other one of the screw shafts differ from each other.

3. The rotary actuator according to claim 2, wherein a pair of the screw shafts and the nut member are engaged with each other through a plurality of rolling members disposed between the screw grooves and the nut grooves.

4. A rotary actuator comprising:
a housing;
a first screw shaft fixedly provided for one end side of the housing and formed, in an outer peripheral surface, with a spiral screw groove;
a second screw shaft provided to be rotatably around an axis thereof in a manner of restricting a movement in the axial direction on another end side of the housing and formed, in an outer peripheral surface thereof, with a spiral screw groove; and
a nut member provided, in an inner peripheral surface thereof, with two kinds of nut grooves corresponding respectively to the screw grooves formed to the first and second screw shafts so as to be engaged therewith, respectively,
wherein the nut member is provided with a flanged portion which divides a space between the nut member and the housing into two operating fluid chambers, the housing is formed with a pair of operating fluid ports for flowing the operating fluid into or out of the two operating fluid chambers, and a lead of the screw groove formed to the first screw shaft is larger than a lead of the screw groove formed to the second screw shaft.

5. The rotary actuator according to claim 4, wherein the first and second screw shafts and the nut member are engaged through a plurality of rolling members disposed between the screw grooves and the nut groove.

6. The rotary actuator according to claim 4, wherein the housing has an outer configuration formed into a cylindrical shape.

7. The rotary actuator according to claim 4, wherein the two operating fluid chambers are sealed by an oil seal disposed between the housing and the nut member.

8. The rotary actuator according to claim 4, wherein the housing and the second screw shaft are disposed to be relatively rotatable through a rotary bearing mechanism, and the rotary bearing mechanism includes an outer race disposed on the housing side and formed, in an inner peripheral surface thereof, with an outer side rolling groove, an inner side rolling groove formed in an outer peripheral surface of the second screw shaft, and a plurality of rolling members disposed, to be rotatable, between the outer side rolling groove and the inner side rolling groove.

9. The rotary actuator according to claim 5, wherein the housing has an outer configuration formed into a cylindrical shape.

10. The rotary actuator according to claim 5, wherein the two operating fluid chambers are sealed by an oil seal disposed between the housing and the nut member.

11. The rotary actuator according to claim 5, wherein the housing and the second screw shaft are disposed to be relatively rotatable through a rotary bearing mechanism, and the rotary bearing mechanism includes an outer race disposed on the housing side and formed, in an inner peripheral surface thereof, with an outer side rolling groove, an inner side rolling groove formed in an outer peripheral surface of the second screw shaft, and a plurality of rolling members disposed, to be rotatable, between the outer side rolling groove and the inner side rolling groove.
